(19) United States
(12) Patent Application Publication
(10) Pub. No.: US 2013/0169097 A1
(43) Pub. Date: Jul. 4, 2013

(54) LOW AXIAL FORCE PERMANENT MAGNET MACHINE

(71) Applicants: Daniel M. Saban, Northville, MI (US); Fang Deng, Novi, MI (US); Seong T. Lee, Lexington, KY (US)

(72) Inventors: Daniel M. Saban, Northville, MI (US); Fang Deng, Novi, MI (US); Seong T. Lee, Lexington, KY (US)

(73) Assignee: Danotek Motion Technologies, Inc., Canton, MI (US)

(21) Appl. No.: 13/555,943

(22) Filed: Jul. 23, 2012

Related U.S. Application Data
(60) Provisional application No. 61/582,311, filed on Dec. 31, 2011.

(51) Int. Cl. H02K 21/02; H02K 21/14; H02K 21/22; H02K 21/12

(52) U.S. Cl. 310/156.08; 310/152

(57) ABSTRACT

An electric machine includes a plurality of teeth separated by a plurality of slots positioned on an armature of the electric machine. Each of the teeth may include at least one bifurcation. A plurality of magnets may be arranged on a main field of the electric machine to form an axial array group. The magnets in the axial array group may be arranged in the main field with respect to each other to create a multi-stepped arrangement having a predetermined step angle. The step angle is determined based on the positioning of the bifurcations and the slots.

### PRIORITY CLAIM

This application claims the benefit of priority from U.S. Provisional Application No. 61/582,311, filed Dec. 31, 2011, which is incorporated by reference.

### BACKGROUND OF THE INVENTION

1. Technical Field

This invention relates to a permanent magnet machine, and more specifically to a winding configuration and a magnet configuration of a permanent magnet machine.

2. Related Art

Permanent magnet machines include motors and generators. Instead of a field winding (typically on the rotor) to which electricity is applied to produce a magnetic field, permanent magnet machines can use permanent magnets to provide the magnetic field. Permanent magnet generators can use a permanent magnet instead of a field coil winding to produce the magnetic field of the rotor. Permanent magnet motors can use permanent magnets on the rotor instead of a field winding to produce a magnet field on the rotor. Torque, on both motors and generators is a function of the resultant field.

### SUMMARY

An electric machine includes an armature having a plurality of teeth separated by slot openings, each of the teeth having at least one bifurcation. The wound armature may be included as part of a stator or a rotor. The electric machine may also include a main field having a plurality of permanent magnets. The permanent magnets may be arranged to form axial array groups on the main field of either the rotor or the stator of the electric machine. The permanent magnets in each of the axial array groups may be positioned with respect to each other based on the position of the teeth bifurcations and the slot openings.

The electric machine may include a rotor and a stator. The axial group array may include a first magnet, a second magnet, a third magnet and a fourth magnet. The axial group array may be positioned symmetrically on the main field about a first axis of the electric machine that is parallel with an axial centerline of the electric machine. The first magnet and the second magnet may be positioned along a second axis parallel with the axial centerline of the electric machine so that the third magnet and the fourth magnet are at least partially positioned therebetween. The third magnet and the fourth magnet may be positioned along a third axis parallel with the axial centerline of the electric machine. The first axis, the second axis, and the third axis may all be different locations on the main field.

The electric machine may include bifurcated teeth positioned circumferentially on the armature of one of the rotor or the stator to form a plurality of slots. Each of the bifurcated teeth may include at least one bifurcation. The magnets may be positioned axially on the main field to form an axial array group along a center step axis that is parallel to an axial centerline of the electric machine. A first group of the plurality of magnets may be offset from the center step axis in a first direction, and a second group of the plurality of magnets may be offset from the center step axis in an opposite direction. The offset of the first and second groups of magnets may be based on a relative position of the bifurcated teeth and the slots with respect to the first and second groups of magnets.

Interesting features of the electric machine include the mounting of the magnets on respective carrier plates that are positioned on the electric machine. The carrier plates may be of uniform dimensions, and the magnets may be mounted in a same predetermined position on respective carrier plates. The respective carrier plates are rotatable between a first position and a second position on the main field of the electric machine. The carrier plates are rotatable to the first position to align the magnet(s) on the respective carrier plate with a first axis, and are rotatable to the second position to align the magnet(s) with a second axis. The first and second axes may be parallel with the axial centerline of the machine, and may be spaced apart from each other by a predetermined distance defined with a step offset. The step offset may be determined based on the relative location of the bifurcated teeth and the slots with respect to the magnets.

Other interesting features include the use of magnet pole arrays to form the axial array groups positioned on the main field of the electric machine. The magnet pole arrays may be formed on the carrier plates. The magnet pole arrays in an axial array group may be step offset from one another to form a multi-step configuration. The step offset may be based on a step angle determined from the bifurcation angles and slot angles included in the machine. The step angle may be based on a first plane intersecting the first axis and the axial centerline and a second plane intersecting the second axis and the axial centerline to form a predetermined angle.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a cut-away side view of an example armature of a permanent magnet machine.

FIG. 2 is a more detailed view of a portion of the armature illustrated in FIG. 1 that depicts examples of armature teeth and armature slots.

FIG. 3 is a more detailed view of a portion of a bifurcated armature tooth, such as one of the armature teeth illustrated in FIGS. 1 and 2.

FIG. 4 is a side view of an example main field of a permanent magnet machine.

FIG. 5 is a perspective schematic view of a portion of the main field illustrated in FIG. 4.

FIG. 6 is an example of a permanent magnet arrangement on a main field.

FIG. 7 is an example of an end view of a main field.

FIG. 8 is an example configuration of permanent magnets in a main field.

FIG. 9 is an example carrier plate that includes permanent magnets.

FIG. 10 is a side view of an example carrier plate.

FIG. 11 is perspective end view of an example carrier plate.

### DETAILED DESCRIPTION OF THE PREFERRED EMBODIMENTS

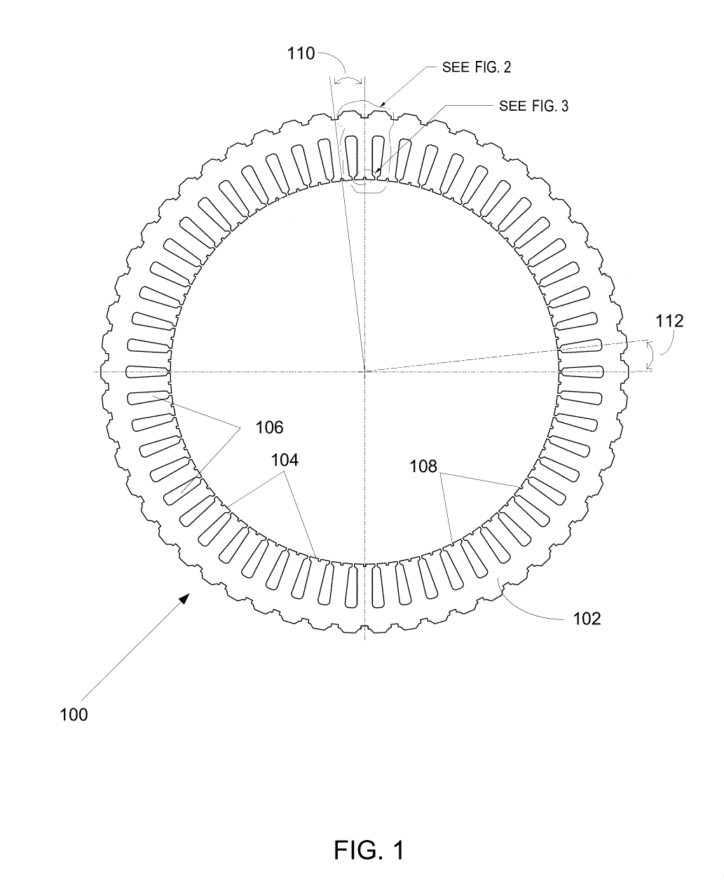

Permanent magnet (PM) synchronous machines include a stationary armature surrounding or within a rotating main field. An example permanent magnet synchronous machine is a generator for use in a wind turbine application. FIG. 1 is an example of an armature 100 that may be included on a rotor or a stator of an electric machine. In FIG. 1, the armature 100 is formed to surround the rotor, however in other examples, the armature could be surrounded by the rotor. The armature 100 includes a plurality of main windings having a number of poles formed in an armature core 102 of the armature 100. The armature core 102 can be formed from a stack of laminations. Each of the laminations in the armature core 102 may be formed to include a plurality of radially extending members separated from each other by apertures. When the laminations are stacked, the radially extending members in corresponding laminations are combined to form armature teeth 104, and the corresponding apertures form slots 106 within which the main windings are positioned. In other examples, the armature core configuration described may be included in a permanent magnet (PM) synchronous machine.

By varying the length of individual laminations in an armature tooth 104, one or more bifurcations 108, or notches, may be formed in each of the armature teeth. Thus, a tooth bifurcation may be present every “x” number of degrees around the armature 100, forming a predetermined bifurcation angle 110 between adjacently positioned armature teeth 104. In FIG. 1, the bifurcation angle 110 formed between tooth bifurcations 108 on adjacent armature teeth 104 is illustrated. In one example, the armature 100 may be a stator that includes fifty-four armature teeth 104, such as stator teeth, with fifty-four corresponding tooth bifurcations 108 spaced apart by about 6.54 degrees. A similar angle also exists between each slot 106, which may be referred to as a slot pitch angle 112, which is measured between adjacently positioned slot openings of the respective slots 106. The corresponding totality of the combination of the angles between the bifurcations 108 and slots 106 may be referred to as slot/bifurcation (SB) angles.

In the example armature 100 of FIG. 1, the SB angles, which are the angles between each slot 106 and each bifurcation 108 is about 3.27 degrees. In other examples, any other bifurcation angles 110, slot pitch angles 112, and SB angles may be used to position the slots 106, armature teeth 104, and corresponding bifurcations 108. For example, if there is one bifurcation 108 in an armature tooth 104, than the angle between a slot opening of a slot 106 and the bifurcation 108 (the SB angle) is one half of the slot pitch angle 112. In the example of two bifurcations 108 in each armature tooth 104, the SB angle would be one third of the slot pitch angle 112.

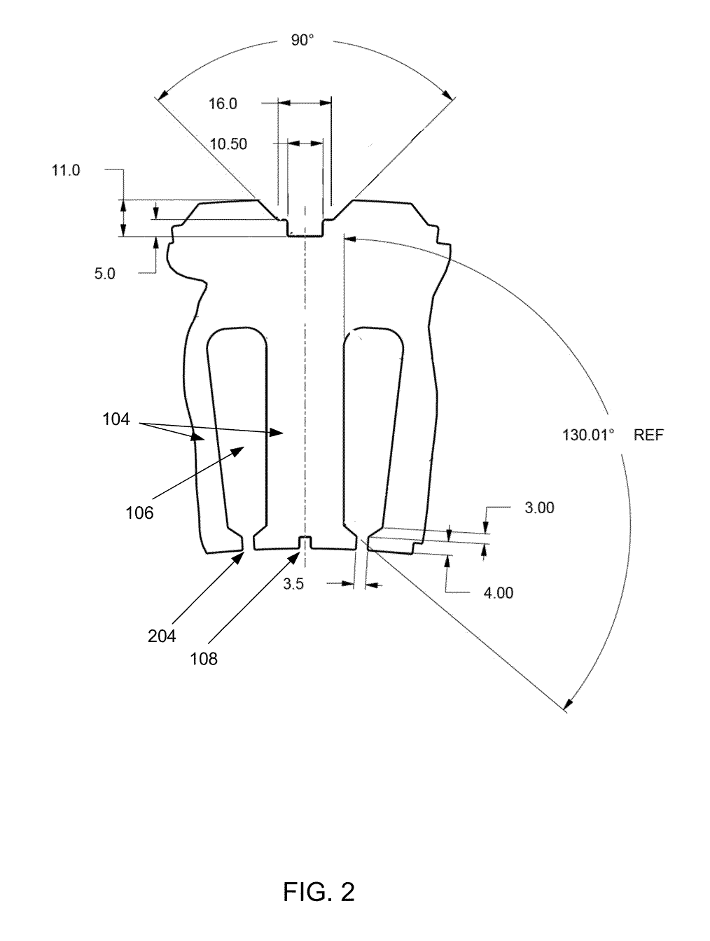

FIG. 2 is an example portion of the armature 100 illustrated in FIG. 1 depicting armature teeth 104 and slots 106. The armature 100 of FIG. 2 could be a portion of a rotor or a stator of an electric machine, but generally may form part of the stator of an electric machine. The bifurcations 108 in the armature teeth 104 may be a predetermined depth and a predetermined width, and corresponding slot openings 202 may be a predetermined size. The predetermined depth and the predetermined width of the bifurcations 108 may be determined in accordance with the predetermined size of the slot openings 202. For example, a ratio between the size of the slot openings 202 and the depth and/or width of the bifurcations 108 may be used. The bifurcations 108 appear to the main field as additional slot openings 202, which results in less tooth ripple flux penetrating into the main field. For example, in the case of one bifurcation being present in each armature tooth 104, the number of slots 106 from the perspective of the main winding may be effectively doubled and the amplitude of the tooth ripple flux may be halved. In other examples, the dimensions and shape of the bifurcations 108, such as the width, depth and height may be determined by any other technique to develop bifurcations that mimic slot openings 202 during operation of the electric machine.

Tooth ripple flux may create two effects that result in lower performance;
1. Torque ripple may be created by tooth ripple flux. Torque ripple creates undesirable mechanical forces which can be transferred to the machine shaft and connected equipment; and
2. Main field eddy currents caused by tooth ripple flux may result in higher losses in the magnets and monolithic conducting components of the main field, lowering efficiency and possibly increasing the temperature of the magnets which will tend to lower the useful magnetic flux produced by the magnets.
   The multi-stepped configuration may effectively operate as a filter, such as a “notch filter” to minimize tooth ripple flux in predetermined harmonics, such as the 17^{th} or 19^{th} harmonic and effectively “tune” the air gap between the armature and the main field to decrease asynchronous magnetic flux and thereby torque ripple. The interaction between the slot opening, tooth bifurcation, and the step offset may be used to effectively minimize torque ripple by applying a filtering effect to the tooth ripple flux. Thus, the tooth ripple flux and main field eddy currents may be minimized in a desired way, such as by filtering only harmonics of interest, and overall performance of the electric machine may be increased.

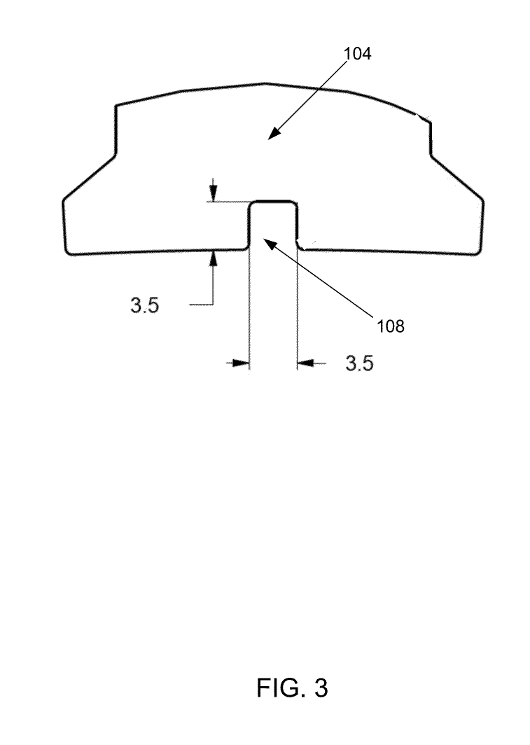

FIG. 3 is an illustration of a portion of an example bifurcated armature tooth 104 such as one of the armature teeth 104 illustrated in FIGS. 1 and 2. In the illustrated examples of FIGS. 2 and 3, the slot opening size may be 3.5 millimeters, and the width and depth of the bifurcations 108 formed in each of the armature teeth 104 may be equal, such as 3.5 millimeters deep, and 3.5 millimeters wide. (see FIG. 3) In other examples, the width and depth of the bifurcations 108 may be different from the size of the slot openings 202, or the width and depth of the bifurcations 108 may be different among different armature teeth 104. In addition, ratios other than a one-to-one ratio may be used between the size of the slot openings 202 and the width and/or depth of the bifurcations 108.

The bifurcations 108 may be in the same relative position on each of the armature teeth 104, such as centered in the armature teeth 104 between the slot openings 202. Accordingly, the bifurcations 108 may be evenly spaced around the armature 100 with respect to each other, and have equal bifurcation angles 110. Alternatively, each of the armature teeth 104 may have two bifurcations 108 that are equally spaced across the respective armature tooth 104. In this configuration, the bifurcation angle 110 between two bifurcations 108 on the same armature tooth 104 may be different than the bifurcation angles 110 between adjacently positioned bifurcations 108 that are formed in different armature teeth 104. The SB angles may be equal and uniform around the armature 100, since the angles between the bifurcations 108 on a respective armature tooth 104, and the angles between the bifurcations 108 and the adjacently positioned armature slots 106 may be equal in order to present uniformly appearing “slots” from the perspective of the main winding. Alternatively, the bifurcation angles 110 may all be substantially or partially non-uniform.

In another alternative example, the bifurcations 108 may be selectively offset from a center 202 of a respective armature tooth 104 such that the bifurcations 108 may be closer to one adjacently located armature slot opening 202 and further from a second adjacently located armature slot opening 202. In this example configuration, the corresponding bifurcation angles 110 may similarly vary, along with the SB angles, which are the angles between the bifurcations 108 and between the bifurcations 108 and the slot openings 202. Thus, the locations of the bifurcations 108 in the armature teeth 104 may be non-uniform with respect to each other, or there may be groups of armature teeth 104 with substantially the same location of the one or more bifurcations 108. Accordingly, the bifurcation angles 110 and the slot pitch angles 112 between the slot openings 204 and the bifurcations 108 may be non-uniform resulting in non-uniform SB angles. Offset or unequally distributed bifurcations 108 can serve to create a separate set (or sets) of tooth ripple flux harmonics; varying widths of bifurcations 108 can also change the tooth ripple flux signature. The result of the unequally distributed bifurcations 108 can be to distribute the total tooth ripple flux harmonic energy across multiple harmonics, not all in-phase with each other. These are secondary tuning techniques that can be combined with magnet edge or pole shaping to optimize a particular desired harmonic filtering effect.

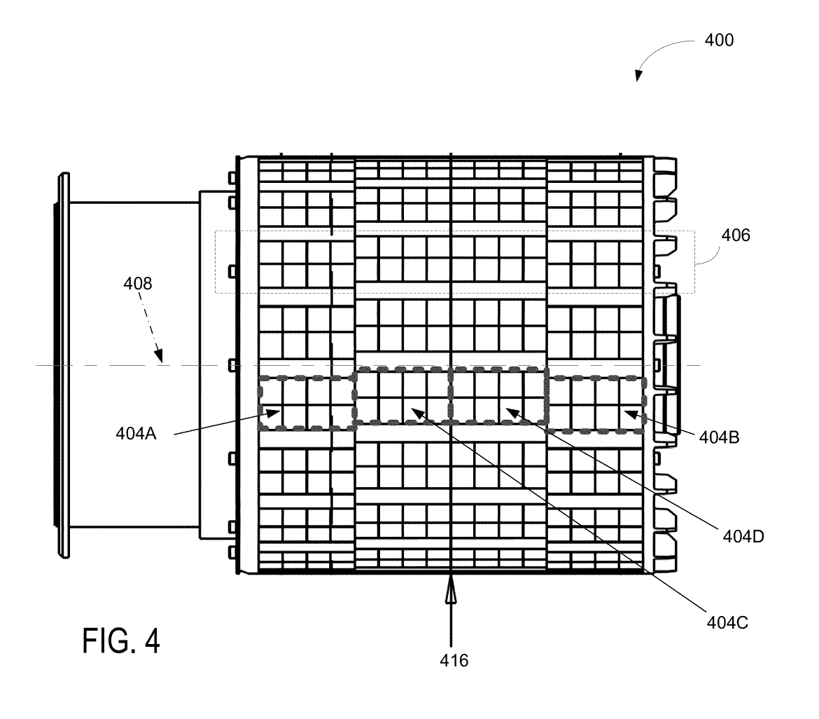

FIG. 4 is a side view of an example main field 400, formed as a hub such as a hub or yoke of an inner rotor, of a permanent magnet machine, in which the yoke, and therefore the main field is positioned within and surrounded by an armature. In other examples, the main field 400 could be formed as a yoke of an outer rotor, in which the yoke is position to surround an armature of a permanent magnet machine. The main field 400 may include one or more permanent magnets 402. The magnets 402 may be single magnets, or groups of similarly aligned magnets formed of ferrite, alnico, rare earth magnets such as neodymium-iron-boron magnets or samarium-cobalt magnets, or any other magnetic material having sufficient magnet field for use in a particular electric machine. The magnets 402 may be disposed on an outer surface of the main field 400 to be aligned in a predetermined position with respect to each other and with respect to the armature teeth.

In one example, the magnets may be grouped in arrays of magnets forming a magnet pole array 404. The term “magnet pole array” denotes that the array is comprised of magnets with a predetermined dipole orientation. Thus, the magnets may be arranged to have like magnetic dipole orientation, or may be arranged to not have like magnetic pole orientation. For example, the magnets may be magnetized as uniform parallel magnets with parallel lines of flux between the north and south poles of each magnet that are perpendicular to the north and south faces of a respective magnet. Alternatively, or in addition, the magnets may be magnetized as radial magnets in which the lines of flux radially extend through the respective magnets such that the lines of flux are not perpendicular to the north and south faces.

The magnets may be grouped in arrays of magnets for ease of handling during manufacturing. Ease of handling involves the ease of carrying and holding the individual magnets during the electric machine manufacturing process. In addition, grouping of magnets may be performed to meet a desired magnet flux density in view of magnet size manufacturing constraints, such as mold size, that limit the overall size of the individual single piece magnets. In addition, arrays that include multiple magnets may minimize eddy current both axially along an axial centerline 408 of the main field 400, and circumferentially around the main field 400 by increasing the impedance of the eddy current path, for example by placing a electrical insulator or physical separator between otherwise contiguously positioned magnets in a magnet array. Different sizing of the array of magnets may have varying degrees of impact on the minimization of eddy currents. For example, in the configuration of FIG. 4, each magnetic pole array may operate with the least amount of eddy currents when compared to a single large magnet.

Each magnet pole array 404 may be positioned in a predetermined position with respect to other magnet pole arrays 404 included on the main field 400. The magnet pole arrays 404 may be formed in axial array groups 406 each including a predetermined number of magnet pole arrays 404. The axial array groups 406 may extend in an axial direction parallel with a shaft of the main field 400 positioned along the axial centerline 408 of the main field 400. The axial array groups 406 may be positioned on the surface of the main field 400 so as to extend from a first end 410 of the main field surface to a second end 412 of the main field surface. Each of the axial array groups 406 may be positioned on the outer surface of the main field 400 with respect to each other to form a substantially contiguous magnetic surface concentrically surrounding the main field 400. In one example, the main field 400 may be included as a rotor of a permanent magnet synchronous machine used as a generator for wind turbine applications. In other examples, the described configuration of the main field 400 may be included as a stator of a permanent magnet synchronous machine.

In the example main field 400 of FIG. 4, there are four horizontal magnet pole arrays 404 forming each of the axial array groups 406. In FIG. 4, an axial array group 406 is identified in a dotted lines box, in which each of four different magnet pole arrays 404 included in the axial array group 406 are identified with dotted lines. The four horizontal axial array groups 406, which include arrays of magnets forming the axial array group 406 are identified in FIG. 4 as a left outer magnet pole array 404A, a right outer magnet pole array 404B, a left central magnet pole array 404C and a right central magnet pole array 404D. In other examples, any number of magnet pole arrays 404 of any size may be used to form axial array groups 406 on the surface of the main field 400. Alternatively, single or multiple magnets may be used in place of an array of magnets within the axial array groups 406.

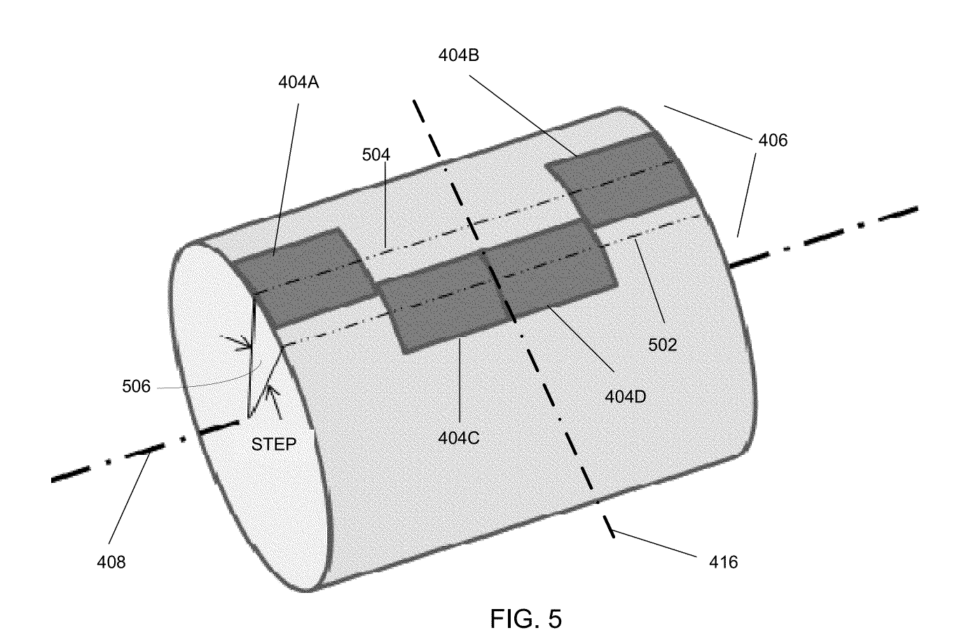

FIG. 5 is an example configuration of an axial array group 406 that may be included in the example main field 400 of FIG. 4, or in any other main field configuration in other examples. Within each of the axial array groups 406, the central magnet pole arrays 404C and 404D may be considered a first group of magnet pole arrays that are positioned in the main field 400 with respect to the outer magnet pole arrays 404A and 404B formed as a second group of magnetic pole arrays. Each of the first and second groups of magnet pole arrays may be arranged along a different axis that lies parallel with the axial centerline of the machine.

In FIG. 5, the first group of magnet pole arrays is positioned along a first axis 502, and the second group of magnet pole arrays is positioned along a second array axis 504. The first and second array axes 502 and 504 are parallel to the axial centerline 408, and are at different locations around the circumference of the main field. The first and second array axes 502 and 504 may be along the magnetic center or mechanical center of the magnetic pole arrays 404. Accordingly, each of the central magnet pole arrays 404C and 404D may be symmetrically aligned with the first array axis 502, and each of the outer magnet pole arrays 404A and 404B may be symmetrically aligned with the second array axis 504. Thus, in the illustrated example, the left central magnet pole array 404C and the right central magnet pole array 404D are substantially aligned so as to be symmetric about the first array axis 502, and the left outer magnet pole array 404A and the right outer magnet pole array 404B are substantially aligned so as to be symmetric about the second array axis 504. In other examples, the first array axis 502 and the second array axis 504 may be along an edge of the magnetic pole arrays 404 in the respective first group of magnet pole arrays and the second group of magnet pole arrays, or any other location that provides uniform axes of the different arrays. The first array axis 502 and the second array axis 504 are in different planes that are separated on the surface of the main field by a step angle 506 and intersect to form the axial centerline 408.

In the example configuration, the two outer magnet pole arrays 404A and 404B are offset, or stepped, in the same direction, by about the same amount with respect to the two central magnet pole arrays 404C and 404D. This may be referred to as a “multi-stepped” configuration. The examples of FIGS. 4 and 5 may also be referred to as a “double stepped” configuration, or a “¼-½-¼ A step(ped)” configuration.

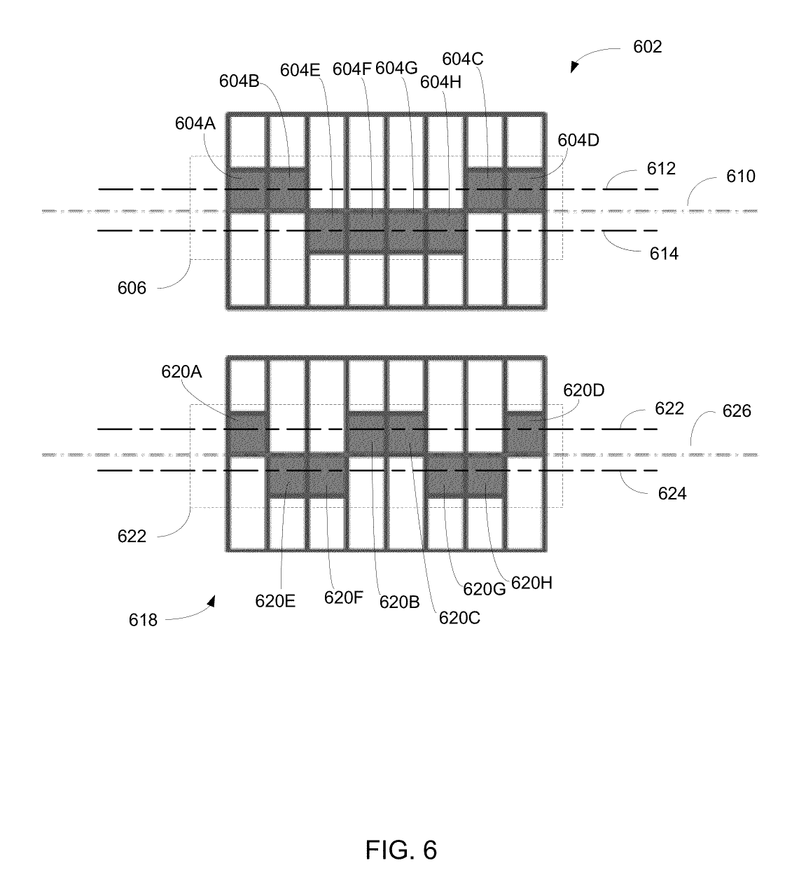

In other examples, other multi-stepped configurations are possible, such as the examples illustrated in FIG. 6. In FIG. 6, a first multi-stepped example configuration 602 includes eight magnet pole arrays 604 that are included in an axial array group 606. In this example, first configuration 602, a group of left magnet pole arrays 604A and 604B and a group of right magnet pole arrays 604C and 604D form a first group of magnet pole arrays aligned along a first axis 612. In addition, a group of central magnet pole arrays 604E, 604F, 604G, 604H form a second group of magnet pole arrays aligned along a second axis 614. The first and second groups of magnet pole arrays are in different planes that are separated on the surface of the main field by a step angle and intersect to form the axial centerline 610. Thus, although there are additional magnet pole arrays, this example configuration may also be referred to as multi-step configuration, a “double stepped” configuration, or a “¼-½-¼ A step(ped)” configuration.

FIG. 6 also includes a second multi-stepped configuration 618 that includes eight magnet pole arrays 620 that are included in an axial array group 622. In this example, first configuration 602, a left magnetic pole array 620A, a pair of central magnetic pole arrays 620B and 620C, and a right magnet pole array 620D a first group of magnet pole arrays aligned along a first axis 622. In addition, a group of left intermediate magnet pole arrays 620E and 620F and a group of right intermediate pole arrays 620G and 620H form a second group of magnet pole arrays aligned along a second axis 624. The first and second groups of magnet pole arrays are in different planes that are separated on the surface of the main field by a step angle and intersect to form a main field axial centerline 626. Thus, this example configuration may also be referred to as multi-step configuration, a “double stepped” configuration, or a “⅛-¼-¼-¼-⅛” step(ped)” configuration due to the positioning of the magnet pole arrays 620 in the axial array group 622.

The multi-stepped configuration is different from either a conventional, “helical” skew or a “Herringbone skew” that could be included in a squirrel-cage induction machine rotor. In this regard, the multi-stepped configuration may be considered similar to digital sampling of an analog function. A conventional helical skew (either a stator skew or a laminated skew rotor) is discretized per each lamination, but the extent spans the desired skew angle in a closely approximated analog fashion. When the main field has a small number of discrete positions possible (one per magnet rather than one per lamination: from a few to tens, to hundreds to thousands) the “step” becomes apparent. A “Herringbone skew” will span the skew angle from one end to the middle and then back again, the total angular traverse being twice the effective skew angle. A conventional skew only spans the skew angle once from top to bottom. If one was to form a conventional skew with few (N) discrete positions the total angle spanned from the extent of the skewed positions would be:

angle_spanned=desired_skew_angle*(N−1)/N Equation 1

With only two discrete positions, such as in the example double-stepped configuration of FIGS. 4 and 5, the step angle to achieve the same effective skew as a Herringbone skew is one half of the skew angle of the Herringbone skew. This may result from different trigonometric identities used by taking a double integral of the flux over the rotor or stator surface for each of the tooth ripple flux harmonics considered.

The decoupling of the undesired tooth ripple flux harmonics attenuates (represented by a penalty function) the desired fundamental flux coupling the armature and the main field. In the example of a conventional skew this penalty is inversely proportional to: the sine of half of the skew angle divided by half of the skew angle; whereas the penalty function for a stepped angle configuration is inversely proportional to the cosine of one-half of the step angle. This holds true for N=2 and is independent of whether the step angle is achieved asymmetrically with only two axial groupings or symmetrically with the double-stepped configuration. The mathematical solution for the penalty factor is different for a multi-stepped configuration with N>2, but increasingly greater values of N eventually approach something similar to the conventional (helical) case. Another way to refer to and describe the double-stepped configuration is to refer to it as a “¼-½-¼ stepped configuration.”

Even for the double-stepped configuration, where N=2, the choice of symmetric or asymmetric arrangements of the magnet pole arrays, is unrelated to the decoupling of the harmonic content, since the offending flux ripple is integrated over the entire stack length. The symmetric arrangement of the magnet pole arrays may correct for (cancel) the axial component of the offending harmonics (and fundamental and all other harmonics). There may be any number of magnet pole arrays occupying one of the two step-positions in the axial array group. The number of magnet pole arrays at each of the two step-positions impacts primarily the manufacturing methods and objectives.

Referring again to FIGS. 4 and 5, the magnet pole arrays 404 included in the axial array group 406 may also be symmetrically aligned with respect to an array centerline 416 of the main field 400 as best illustrated in FIG. 5. The array centerline 416 may substantially equally divide the main field hub along a plane perpendicular to the axial centerline 408. Thus, in FIGS. 4 and 5, the left central magnet pole array 404C and the right central magnet pole array 404D are symmetrically aligned with respect to the array centerline 416 of the main field 400. In addition, the left outer magnet pole array 404A and the right outer magnet pole array 404B are symmetrically aligned with respect to the array centerline 416. In examples where additional magnet pole arrays are included in the multi stepped configuration, such as the examples of FIG. 6, the magnet pole arrays 604 may be positioned on the main field to remain symmetric with respect to the respective array axis, and the array centerline of the main field. Thus, an axial array group preferably includes four, eight, sixteen, thirty-two, sixty-four, or some other multiple of four magnet pole arrays to accommodate maintaining the magnet pole arrays in a symmetric configuration about the array centerline of a particular main field. The single stepped configuration has only two magnet pole arrays, and will not be as effective as the double stepped configuration at reducing the axial force imparted on the rotor.

As also illustrated in FIG. 5, the first group of magnet pole arrays and second group of magnet pole arrays may be spaced or stepped on the surface of the main field hub by a predetermined angular distance based on a predetermined step angle 506. The angular difference between the plane of the first array axis 502 and the plane of the second array axis 504 may represent the step angle 506. In some embodiments, the step angle 506 may be the same as a magnet angle between the magnetic pole center of the magnet pole arrays, or between the mechanical pole center of the magnet pole arrays, or an edge angle between like edges of the first and second group of magnet pole arrays. In other examples, the angular orientation of the first and second groups of magnet pole arrays may be such that the step angle 506, the magnet angle, and the edge angle are different. The step angle is typically relatively small, and may be less than 10 mechanical degrees, and can be much less. Accordingly, even with the step offset of some of the magnet pole arrays 404 in an axial array group 406, a plane intersecting all of the magnet pole arrays 404 and the axial centerline 408 is present.

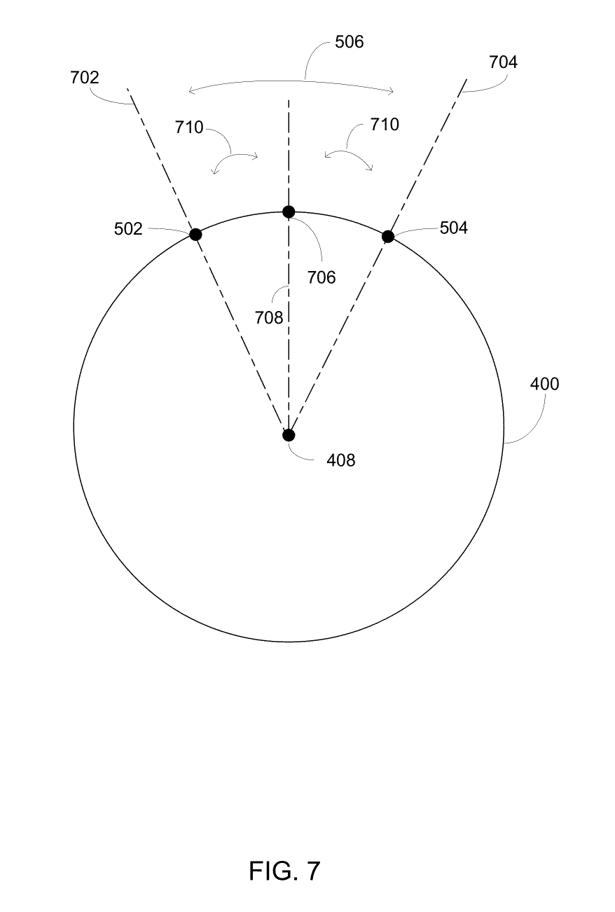

FIG. 7 illustrates an end view of the example main field 400 of FIGS. 4 and 5, that includes the axial centerline 408. In other examples, an armature could be illustrated. In FIG. 7 a first plane 702 that intersects the first axis 502 and the axial centerline 408 and a second plane 704 that intersects the second axis 504 and the axial centerline 408 are illustrated. The step angle 506 is identified as the angular distance between the first plane 702 and the second plane 704. The axial array group and corresponding magnet pole arrays included therein, as shown in FIGS. 4 and 5, are not illustrated in FIG. 7 for purposes of clarity, and the step angle 506 illustrated in FIG. 7 is not to scale, and is shown as significantly larger with respect to the main field size for purposes of clarity.

In the “double stepped” configuration example of FIG. 7, the first axis 502 and the second axis 504 represent the two discrete positions. Positioned midway between the first and second axes 502 and 504 on the main field is a center step axis 706, which is the plane intersecting all the magnet pole arrays such that all the magnet pole arrays are along the center step axis 706. The first axis 502 and the second axis 504 are an equal distance in opposite directions from the center step axis 706. Thus; the magnet pole arrays included in the axial group array may be symmetrical with respect to the center step axis 706 as a whole, since the magnet pole arrays may be positioned to be balanced across the center step axis 706. In addition, the center step axis 706 forms a third plane 708, or center step plane, that intersects the center step axis 706 and the axial centerline 408. The third plane 708 is equally separated from each of the first and second axes 502 and 504 by a center step angle 710, thus, each of the axial group arrays may be symmetrical with respect to a respective center step axis 706 of a respective axial group array.

Referring to FIGS. 1-7, the relative positioning of the magnet pole arrays 404 to form the multi-stepped configuration may be based on the relative position of the magnet pole arrays 404 with respect to the bifurcations 108 in the armature teeth 104 and/or the slots 106 in the armature 100. (FIGS. 1-3) Thus, in the examples of FIGS. 1-5, the amount of step, or offset of the outer magnet pole arrays 404A and 404B relative to the position of the inner magnet pole arrays 404C and 404D may be determined based on the position of the bifurcations 108 and the slots 106 in the armature 100. More specifically, the positioning of the magnet pole arrays 404 on the main field 400 may be determined based on the relationship between the predetermined step angles 506 of the axial array group 406, and the bifurcation angles 110 of each of the respective armature teeth 104 in combination with angles between the slot openings 204 and the bifurcations 108. Thus, the predetermined step angles of the axial array groups 406 containing the magnet pole arrays 404 is related to the slot pitch angles 112 and the bifurcation angles 110 of the armature 100.

The tooth bifurcations 108 and the slot openings 204 of the armature 100 may be considerations in the determination of the predetermined step angle 506 of the multi-stepped configuration. As described herein, it is advantageous to reduce the desired effective step angle 506. Incorporating bifurcations 108 into the multi-stepped configuration design is a way to do this. The desired effective step angle 506 in a multi-stepped configuration main field may be derived from the number of armature slots 106, however with bifurcated armature teeth 104, this can be modified. In the example of uniformly spaced bifurcations 108 sized to be equivalent in size to the slot openings 204, the desired effective step angle 506 may be derived from the sum of tooth bifurcations 108 and armature slots 106 (the step angle 506 is reduced by half for one bifurcation 108 per armature tooth 104, by a third for two bifurcations 108 per armature tooth 104, etc.). In the example of a armature 100 having a single bifurcation 108 per armature tooth 104, the predetermined step angle between the steps in the example of the ¼-½-¼ stepped configuration (FIGS. 4 and 5) may be equal to one half of the bifurcation angle 110 between the uniformly spaced tooth bifurcations 108 and/or the armature slot openings 204.

Referring again to FIGS. 4 and 5, in general terms, one half of the magnet pole arrays 404 included in a respective axial array group 412 can be offset by half of the step angle 506 in the direction of rotation of the main field 400, and offset by one half of the step angle 506 opposite the direction of rotation. This offset of each of the axial array groups 406 may be referred to as an “step offset,” which spans half of the step angle 506. Thus, in the example of an armature 100 without bifurcations 108 in the armature teeth 104, the step angle 506 may be half of the skew angle. In the present embodiments the tooth ripple harmonic flux (h+ and h−) may be decoupled from the main field where:

h+=m*2*(S*(1+B))/P+1, Equation 2a

n+=m*2*S/P+1 Equation 2b

and

h−=m*2*(S*(1+B))//P−1 Equation 3a

n−=m*2*S/P−1 Equation 3b

where m is an integer, S is the number of slots 106 in the armature core 102, B is the number of bifurcations 108 per armature tooth 104, and P is the number of poles of the fundamental airgap flux, typically the same as the number of poles of one of the armature windings. If there are no tooth bifurcations 108, then B goes to zero thereby minimizing any decoupling, reducing h− to n− and h+ to n+ (Eqns 2a & 3a to Eqns 2b & 3b respectively). Higher numbers of bifurcations B 108 in each of the armature teeth 104 may move the undesirable harmonics into higher fundamental frequencies, which may also have some electromagnetic performance benefits.

A “skew angle” (defined as the angular skew between the extreme ends of the lamination stack of the effective helix created when offsetting each lamination of the main field) for decoupling slot order harmonics n+ & n− (in either an induction or a synchronous machine, which is a permanent magnet machine) may be taken to be an α_mech of one armature slot pitch:

α_mech[radians]=(2*π)/S, Equation 4

or

α_mech[degrees]=360/S; Equation 6

and
α_elec may be represented as an electrical angle as:

α_elec[radians]=(P/2)*(2*π)/S, Equation 6

or

α_elec[degrees]=(P/2)*(360/S. Equation 7

With tooth bifurcations, decoupling tooth ripple harmonic flux h+ & h− with a conventionally skewed main field:

αB_mech[radians]=(2*π)/(S*(1+B)), Equation 8

or

αB_mech[degrees]=360/(S*(1+B)). Equation 9

The step angle can be made integer multiples of half the slot bifurcation angle, but at least some preferable designs can short pitch (rather than full-pitch) the armature coils to minimize the step angle to one half of the bifurcation angle, which is typically the minimum desired step angle. Changing the step angle can have a similar in effect to short pitching the coils, however, changes in step angle instead of short pitching the coils can be advantageous since the machine still includes the benefits of full pitch windings. Thus, instead of short pitching the coils, integer multiples of the bifurcation angles may be used to decouple undesired harmonics at odd multiples of the slot bifurcation angle. Thus, the minimum step angle can be a desired step angle to achieve decoupling of desired target harmonics. In addition, odd multiples of the minimum step angle can achieve similar results, however, at the cost of further reduction in fundamental flux due to resultant decoupling between armature and main field.

Thus, in the present embodiments the step angle can be:

“step angle”(mechanical)[radians]=αB_mech[radians], Equation 10

or

“step angle”(mechanical)[degrees]=αB_mech[degrees]. Equation 11

Thus, in a multi-stepped configuration, the step angle (δ) may be:

δ=αB_mech+Δ+ρ, Equation 12

where Δ is an offset angle intended to compensate for saturation effects and is normally zero for a surface mount main field, but could be non-zero for an embedded embodiment, and ρ represents an offset angle for more linear geometric effects and may be used to compensate for pole tip shaping in surface mount main fields or to weight the decoupling effect differently between tooth ripple harmonic flux h+ and h−, but can typically be taken as zero.

During operation, the example embodiments described use armature tooth tips with a bifurcated profile to increase the apparent frequency of the tooth ripple flux and decrease the amplitude. In addition, a multi-stepped configuration permanent-magnet main field is used to decouple the tooth-ripple harmonic flux from the main field in such a way so as to minimize the conveyance of an axial force onto the main field body, such as the rotor body in a permanent magnet synchronous generator by reducing the unbalanced axial component of the flux linking armature and main field. The multi-stepped configuration main field allows the axial component of the (tooth-ripple flux induced) force vector to cancel between the ends of the main field. The segmentation of the magnets (or magnet pole arrays) in the axial array groups, and the number of bifurcations may be optimized with respect to reduction of losses, air gap length, and manufacturing cost.

Additionally, the performance of a machine that includes these features may be sensitive to the shape of the leading/trailing corner of the magnet pole and the pole arc. In general, shaping of the edges of the magnet or magnets in the magnet pole arrays may not impact the step angle, however, asymmetric edge shaping can move the magnetic pole centers circumferentially around the radius of the machine. A pole arc, or pole arc angle, is the circumferential angle spanned by the physical limits of the magnet or magnet pole array with respect to the axial center line of the machine. In other words, the circumferential extending dimensions of a magnet pole array around the radius of the main winding forms the pole arc angle between planes formed at opposite edges of the magnet pole array that intersect at the axial centerline to form the pole arc angle. Chamfering or shaping the edges of one or more magnets in the magnet pole array may not change the “actual” pole arc since the opposite edges (and therefore the planes) of a magnet remain the same circumferential distance apart, but can change the “effective” magnetic pole arc. Typically, the pole arc angle should be greater than the step angle.

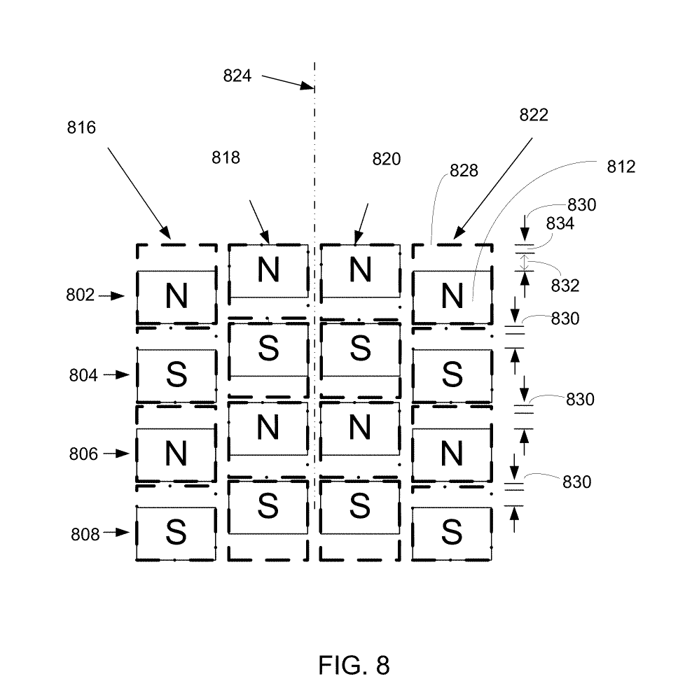

FIG. 8 is an example illustration of the configuration of the north (N) poles and south (S) poles in each of four different axial array groups 802, 804, 806 and 808. The first and second axial array groups 802 and 804 cooperatively form a first north/south pair or group of axial array groups, and the third and fourth axial array groups 806 and 808 form a second north/south pair or group of axial array groups. Each of the magnet pole arrays 812 in one of the axial array groups may be magnetized to have the same north (N) pole or south (S) pole. Between a pair of axial array groups, each of the magnet pole arrays 812 may have similarly oriented north and south poles. Thus, for example, all of the magnet pole arrays 812 in the first axial array group 802 may be configured with a north (N) pole, and all the magnet pole arrays 812 in the second axial array group 804 may be configured as south (S) poles.

This example includes axial pole arrays 812 in a similar configuration to the outer and central pole arrays as illustrated in the example double stepped configuration of FIGS. 4-5. Thus, the fourth axial array group 808, for example, includes a left outer magnet pole array 816, a left central magnet pole array 818, a right central magnet pole array 820, and a right outer magnet pole array 822. In addition, similar to the example of FIG. 5, the left central magnet pole array 818 is position on the main field symmetrically with respect to the right central magnet pole array 820 about an array centerline 824, and the left outer magnet pole array 816 is symmetrical with the right outer magnet pole array 822 about the array centerline 824. In other multi-stepped configurations, additional or fewer poles can be present.

In FIG. 8, each of the magnet pole arrays 812 is illustrated on a uniform carrier plate 828 having an interpole gap 830. The carrier plate 828 is uniform due to having the same dimensions for all the carrier plates 828 on the machine. The interpole gap 830 is the area between adjacently positioned magnet pole arrays 812 that are included in different axial array groups. Each interpole gap 830 includes the step offset 832, and an interpole space 834 that provides manufacturing and assembly tolerances. In alternative examples, other configurations of carrier plates are possible, as previously discussed.

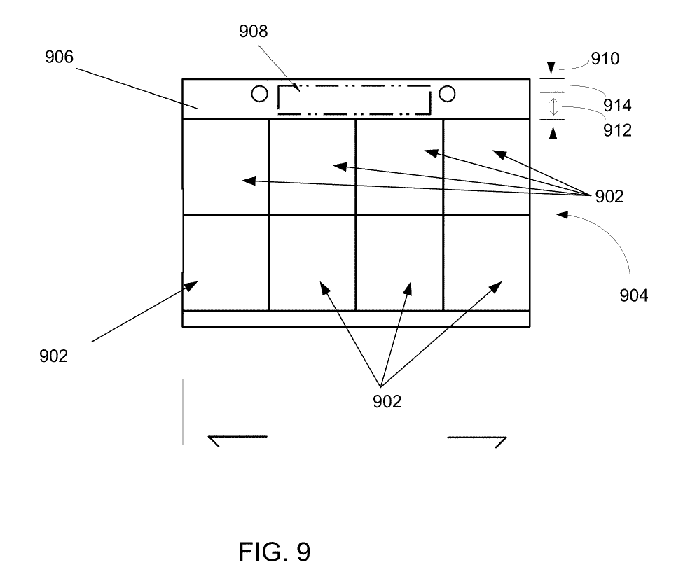

FIG. 9 illustrates a detailed example of an array of magnets 902 included in a magnet pole array 904 that are mounted on a single carrier plate 906. Depending on the magnetization of the magnets, the configuration of FIG. 9 may represent a north pole or a south pole within an axial magnet group. Accordingly, efficiency of manufacturing and assembly is advantageously improved due to fewer parts, interchangeability of parts and flexibility in orientation of the metal plates on the main field. In addition, an array of magnets may be handled as a single piece despite actually being a plurality of magnets due to being fixedly mounted on the carrier plate 906. Alternatively, in another example, a single magnet may be mounted on the carrier plate 906, and still provide uniformity in manufacturing due to reduced part count and flexibility in orientation and mounting of the plate on the main field. Thus, part count may be minimized, and the electric machine manufacturing process may be standardized.

Use of a carrier plate 906 to contain the magnet pole array 904 results in a reduced part count during the manufacturing process, and standardized manufacturing processes. For example, components used to make a magnet pole array 904 of North or South polarity can be substantially identical, but magnetized in opposite polarities. The carrier plates 906 may also include a nameplate 908. The nameplate 908 may include identifying information of the magnets 902, the machine upon which the carrier plate 906 can be installed, and any other information.

The magnets 902 may be mounted on the carrier plate 906 to create an interpole gap 910. The interpole gap 910 includes a step offset 912 and a interpole space 914. All of the magnets 902 may be mounted on carrier plates 906 having the same dimensions. In addition, the magnets may be mounted in the same configuration and location on each of the carrier plates 906. As previously discussed, the step offset 912 may provide a fixed predetermined offset between adjacently located magnet pole arrays 904 in an axial group array. As a result, the step offset 912 may provide the previously discussed step angle between magnet pole arrays 904 included in an axial array group. Thus, in an axial array group such as the examples illustrated in FIGS. 5 and 8, the different positioning of the magnet pole arrays 904 in the axial array group, such as between the left outer magnet pole array and the left central magnet pole array, may be achieved using the same carrier plate 904 and magnet configuration by rotating the carrier plate 180 degrees prior to installation on the main field, and magnetizing the magnets on the carrier plate with opposite poles. In other words, in the example of an axial array group, the step offset 912 between the central magnet pole arrays and the outer magnet pole arrays may be achieved by rotating two of four of the respective plates 180 degrees from a first orientation to a second orientation before installation of the carrier plates to form the axial group array. In addition, uniformly sized and shaped magnets 902 may be mounted on all of the plates 906 as illustrated in the example of FIG. 9 in which eight uniformly sized magnets are illustrated. Further, since the plates 906 are uniformly dimensioned, the plates 906 may be symmetrically aligned along the center step axis

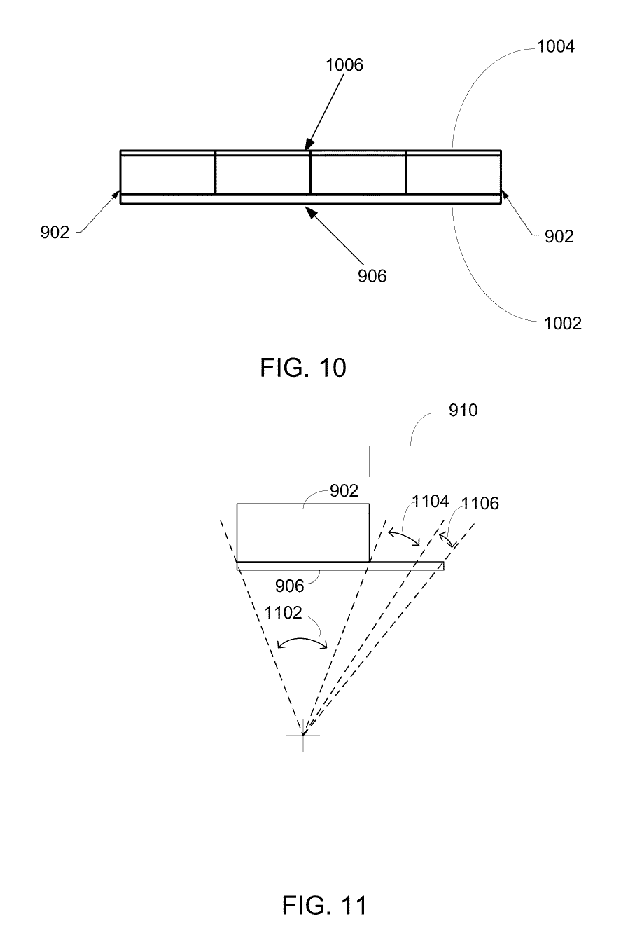

FIG. 10 is a perspective side view of an example of the carrier plate 906 having a plurality of magnets 902 mounted thereon. The magnets 902 may be rigidly maintained in position on the carrier plate 906. A first side 1002 of each of the magnets 902 may be contiguously mounted on the carrier plate 906. A second side 1004 of each of the magnets 902 may be contiguous with a hold down 1006, such as a wrap, a banding, or any other material configured to surround and be concentric with the main field while maintaining contiguous contact with the second side 904 of the magnets 902 to maintain the magnets 902 on the carrier plate 904 as the main field spins.

FIG. 11 is a perspective end view of the example carrier plate 906 illustrated in FIGS. 10 and 11. In FIG. 11, the magnet 902 is shown as occupying a portion of the carrier plate 906, adjacent to the interpole gap 910. A pole arc angle 1102, and a portion of the step angle 1104, such as ½ of the step angle are also illustrated. In addition, the combination of the portion of the step angle 1104, and an interpole gap angle 1106 define the width of the interpole gap 910 on the carrier plate 906. As indicated in the example of FIG. 11, the pole arc angle 1102 is typically greater than the portion of the step angle 1104. The total angle that is the combination of the pole arc angle 1102, the portion of the step angle 1104, and the interpole gap angle 1106 may be equal to 360 degrees divided by the number of poles in the machine:

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. An electric machine comprising:
an armature having a plurality of armature teeth separated by slot openings, each of the armature teeth having at least one bifurcation; and
a main field having a plurality of permanent magnets mounted on the main field to form an axial array group in which the permanent magnets are positioned with respect to each other based on the position of the at least one bifurcation and the slot openings.

2. The electric machine of claim 1, wherein a first group of the permanent magnets included in the axial array group are positioned along a first axis on the main field, and a second group of permanent magnets are positioned along a second axis of the main field, the first axis and the second axis being parallel with an axial centerline of the main field, and being at different locations around the circumference of the main field.

3. The electric machine of claim 2, wherein a first plane intersecting the first axis and the axial centerline and a second plane intersecting the second axis and the axial centerline form a predetermined angle.

4. The electric machine of claim 3, wherein the predetermined angle is determined based on a armature tooth bifurcation and an armature slot position.

5. The electric machine of claim 1, wherein the axial array group comprises a plurality of magnet pole arrays, each of the magnet pole arrays mounted on a plate that is detachably mounted on the main field.

6. The electric machine of claim 1, wherein the permanent magnets forming the axial array group are positioned symmetrically with respect to an array centerline of the electric machine that is perpendicular to an axial centerline of the electric machine, and are also symmetric with respect to a center angle axis that is parallel to the axial centerline of the electric machine.

7. The electric machine of claim 1, wherein a first and second one of the permanent magnets is positioned on the main field in a first position, and a third and fourth one of the permanent magnets is positioned in a second position on the main field that is offset from the first position, a predetermined step angle formed between the first and third permanent magnets and between the second and fourth permanent magnets.

8. The electric machine of claim 7, wherein the first and third permanent magnets are symmetrically positioned on the main field with respect to an axial centerline, and the second and fourth permanent magnets are symmetrically positioned with respect to the axial centerline, and all of the first, second, third and fourth permanent magnets are symmetrical positioned on the main field with respect to an array centerline of the main field.

9. An electric machine comprising:
a main field and an armature;
an axial group array comprising a first magnet, a second magnet, a third magnet and a fourth magnet, the axial group array positioned symmetrically on the main field about a first axis of the electric machine that is parallel with an axial centerline of the electric machine;
the first magnet and the second magnet positioned along a second axis parallel with the axial centerline of the electric machine so that the third magnet and the fourth magnet are positioned at least partially therebetween; and
the third magnet and the fourth magnet positioned along a third axis parallel with the axial centerline of the electric machine, the first axis, the second axis, and the third axis all being different locations on the main field.

10. The electric machine of claim 9, wherein the first axis is a center step axis, and the first magnet and the second magnet are positioned offset from the center step axis a predetermined distance in a first direction, and the third magnet and the fourth magnet are positioned offset from the center step axis the predetermined distance in a second direction opposite the first direction.

11. The electric machine of claim 9, wherein the second axis and the third axis are spaced away from the first axis in opposite directions by an equal predetermined distance.

12. The electric machine of claim 9, wherein the armature comprises a plurality of bifurcated teeth and a plurality of slots formed between the bifurcated teeth, and an angular distance between the second axis and the third axis is based on a bifurcation angle formed between each of the bifurcated teeth, and a slot angle formed between each of the slots.

13. The electric machine of claim 9, wherein each of the first magnet, the second magnet, the third magnet and the fourth magnet are included on a respective uniformly sized carrier plate having predetermined dimensions.

14. The electric machine of claim 13, where the carrier plates are positioned symmetrically along the first axis.

15. The electric machine of claim 14, where the first magnet, the second magnet, the third magnet and the fourth magnet are mounted on the respective carrier plates in a same predetermined position.

16. The electric machine of claim 15, where the respective carrier plates are rotatable between a first position and a second position on the main field, the carrier plates rotatable to the first position to align the first magnet and the second magnet with the first axis, and rotatable to the second position to align the third magnet and the fourth magnet with the second axis.

17. An electric machine comprising:
a plurality of bifurcated teeth positioned circumferentially on an armature included in the electric machine to form a plurality of slots, each of the bifurcated teeth comprising at least one bifurcation;
a plurality of magnets position axially on a main field included in the electric machine to form an axial array group along a center step axis that is parallel to an axial centerline of the electric machine; and
a first group of the plurality of magnets offset from the center step axis in a first direction, and a second group of the plurality of magnets offset from the center step axis in an opposite direction, wherein the offset of the first and second groups of magnets is based on a relative position of the bifurcated teeth and the slots with respect to the first and second groups of magnets.

18. The electric machine of claim 17, where the first group of the plurality of magnets includes at least two magnets that are positioned on the main field with at least part of the second group of magnets therebetween.

19. The electric machine of claim 17, further comprising a carrier plate having predetermined dimensions, and where each of the plurality of magnets are mounted on a respective carrier plate having the predetermined dimensions, each carrier plate rotatable to a first position to position the first group and rotatable to a second position to position the second group on the main field along the center step axis.

20. The electric machine of claim 19, wherein the carrier plate includes a magnet pole array formed from at least two of the magnets, and at least one of the at least two magnets include a chamfered edge to form a leading or trailing edge of the magnet pole array.

21. The electric machine of claim 17, wherein the main field is included on a rotor of the electric machine and the armature is included on a stator of the electric machine.

22. The electric machine of claim 21, wherein the rotor is surrounded by the stator.

23. The electric machine of claim 21, wherein the stator is surrounded by the rotor.

24. The electric machine of claim 17, wherein the at least one bifurcation is formed on each of the bifurcated teeth with at least one of a width and a depth that are substantially equal to a size of a slot opening formed between bifurcated teeth that are adjacently positioned on the armature.

25. The electric machine of claim 24, wherein the at least one bifurcation is positioned in a first location on a first bifurcated tooth, and positioned in a second location on a second bifurcated tooth, the first location being a different location on the bifurcated teeth than the first location.

26. The electric machine of claim 17, where the magnets are uniformly sized.
